(19) United States
(12) Patent Application Publication
(10) Pub. No.: US 2014/0279318 A1
(43) Pub. Date: Sep. 18, 2014

(54) PRE-BILL TIME INFORMATION SERVICE

(71) Applicant: NO SURPRISES SOFTWARE, LLC, Columbus, OH (US)

(72) Inventors: Robert Friedman, Columbus, OH (US); David B. Schottenstein, Bal Harbor, FL (US)

(73) Assignee: NO SURPRISES SOFTWARE, LLC, Columbus, OH (US)

(21) Appl. No.: 13/828,189

(22) Filed: Mar. 14, 2013

(51) Int. Cl. G06Q 30/04

(52) U.S. Cl. CPC G06Q 30/04
USPC 705/32

(57) ABSTRACT

A method, apparatus and program product support secure client access to pre-billed time information from a service provider accounting system. By doing so, a client is able to view pre-billed time information, such as time entries for a service provider's timekeepers that have been entered into a service provider accounting system, prior to those time entries being billed to the client.

### FIELD OF THE INVENTION

The invention is generally related to computers and computer software, and in particular, to accounting software for use by lawyers, accountants, and other service providers.

### BACKGROUND OF THE INVENTION

Service providers such as lawyers, accountants, and the like have traditionally charged clients based upon the amount of time spent by various personnel on client projects. Each person that is billed out in this manner is typically referred to as a timekeeper, and the total charges incurred by a client for a timekeeper's work product is often a function of the amount of time spent by the timekeeper and the timekeeper's billing rate, usually expressed in an amount per hour. While alternative billing arrangements may also be used, e.g., based on a fixed cost per project or a previously-negotiated reduced billing rate, the costs incurred by most service provider clients are still predominantly based on the amount of time spent by various timekeepers performing services for those clients.

Various types of accounting software and systems have been developed for use by service providers to facilitate the tracking of time spent by timekeepers, e.g., in the form of daily time entries, as well as to track additional costs such as travel costs, postage, government filing fees, copying charges, and other reimbursable, out-of-pocket expenses. Such accounting software also typically provides an ability for invoices to be generated and sent out to clients, as well as to record and track client payments. Invoices typically include entries identifying what timekeepers worked on a project, what days those timekeepers worked on the project and for how long, and what those timekeepers did on those days.

In addition, due the increasing use of the Internet and electronic banking, many types of accounting software now support a number of more sophisticated and useful features. For example, electronic invoicing and electronic payment may be supported to reduce the need for paper, simplify electronic data storage and speed up the invoicing and payment processes. In addition, cloud computing is increasingly being used so that a service provider's data is stored remotely and accessed over the Internet, which eliminates the need for a service provider to locally install and manage accounting software and the data used thereby. Moreover, many service provider accounting systems provide limited access rights to clients, e.g., to permit clients to view their invoices and payment history.

One source of frustration for both service providers and their clients is the amount of time that it typically takes for work spent on a client project to be recorded, invoiced and ultimately paid. Many law firms, for example, bill their clients on a monthly basis, i.e., use a monthly billing cycle. In addition, many law firms require each invoice for a client project to be manually reviewed and edited by an individual responsible for the client or the project (e.g., a billing partner). Given that these individuals are often also responsible for doing billable work for clients, this review process is often considered to be a lower priority task than more urgent and billable client projects, which often leads to invoices being sent to clients near the end of a billing cycle, and in some cases, invoices being pushed into subsequent billing cycles.

Thus, assuming a timekeeper works on a client project on the first day of a month, a draft invoice with that work recorded will not be generated until sometime in the following month, and it may take several weeks until the invoice is reviewed, revised, approved and ultimately forwarded to a client. Thereafter, a client may take 30-60 days to pay the invoice, resulting in a typical time period of 90-120 days between when a timekeeper works on a project and when the service provider is compensated for the work.

In addition, this delay can be even more substantial when clients are billed on a project-by-project basis. On some types of projects, for example, a client may be provided with an estimate of what the total project cost will be, and the work performed on the project will not be billed out until the project is complete so the service provider can ensure that the invoice matches the original estimate. Therefore, if a particular project takes four months to complete, it may be nearly six months between the time work begins on a project and when a client receives an invoice for the work, and nearly eight months before payment is received by the service provider.

Beyond the monetary issues associated with these delays, however, is the often greater concern of project management. First, it is important in many instances for work on a project to proceed in a timely and efficient manner so that any deadlines can be met and so that the service provider and/or client are not rushing to complete a project at the last minute. Second, it is important in many instances for the time spent on a project to be monitored to ensure that excessive time and expenses are not being incurred on a project.

While in many instances a service provider and client will not formally agree to a particular cost for a project, a client will often have some expectation of what a reasonable cost is for the project. In other instances, a service provider may provide a client with an estimate, or more formally agree to a fixed cost for the project. In the case where a service provider and client have agreed on a total cost for a project, any time spent on the project that exceeds the total cost will often require the service provider to write off the excessive costs. In the case where no agreement was made in advance, the client may receive an invoice for an amount that far exceeds the client expectations, often straining the relationship between the client and the service provider, as the client will typically either pay the invoice reluctantly or contact the service provider to negotiate a reduction in the invoice.

One significant reason why project management is such a concern is that the work performed on a project is often not appropriately monitored in a timely fashion, and the fact that an excessive amount of work has been expended on a project is often not known until it is too late. Particularly from the perspective of the client, the client is often unaware of what progress being made on its projects since even if the client has access rights to the service provider's accounting system for the purposes of viewing invoices and payments, the client is not provided with access to any information associated with activities that occur prior to invoicing, including, for example, daily timekeeper entries and any incurred out-of-pocket expenses. In addition, even from the perspective of a service provider, an individual responsible for a project may not always keep a close watch on the costs being incurred on a project until the invoice is ready for review.

Traditionally, some clients have addressed this lack of knowledge by contacting the service provider on a periodic basis to check on the progress of a project, e.g., by calling or emailing the individual managing the project or the individuals actually working on the project. Such contacts, however, take time out of the day for both the client and the service provider, and in some instances may strain the relationship between the client and the service provider. Nonetheless, such contacts are often the only way that a client can ensure that its projects are within budget and on schedule.

Service providers and their clients increasingly view their relationships as collaborative relationships, a viewpoint that is only enhanced through the use of computer technology that facilitates the exchange of information, e.g., invoices and payment history, between these parties. Nonetheless, due to the limited ability of clients to know what is going on with their projects prior to being invoiced, as well as the potential for clients to be surprised by unexpected charges, barriers in these relationships still remain. Therefore, a significant need exists in the art for an improved method of facilitating the management of service provider projects by clients.

### SUMMARY OF THE INVENTION

The invention addresses these and other problems associated with the prior art by providing a method, apparatus and program product that support secure client access to pre-billed time information from a service provider accounting system. By doing so, a client is able to view pre-billed time information, such as time entries for a service provider's timekeepers that have been entered into a service provider accounting system, prior to those time entries being billed to the client.

Therefore, consistent with one aspect of the invention, client access to pre-billed time information associated with work performed by a service provider on behalf of the client is provided by retrieving pre-billed time information from an accounting system, controlling access to the pre-billed time information, and in response to a request from the client user to which access has been granted for the pre-billed time information, communicating the pre-billed time information to the client user.

Consistent with another aspect of the invention, client access to pre-billed time information associated with work performed by a plurality of service providers on behalf of a plurality of clients is provided by interfacing a pre-billed time information service with a plurality of service provider accounting systems external to the pre-billed time information service and associated with the plurality of service providers to retrieve pre-billed time information associated with a plurality of clients from the plurality of service provider accounting systems on a real-time basis, for each service provider among the plurality of service providers, establishing access rights for clients of such service provider in the pre-billed time information service in response to user input received from at least one service provider user associated with such service provider, and, for each client among the plurality of clients, in response to at least one request from a client user associated with such client, communicating pre-billed time information associated with work performed for such client by at least a subset of the plurality of service providers and for which access rights have been established.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of an example hardware and software environment suitable for implementing a pre-bill time information service consistent with the invention.

FIG. 2 is a flowchart illustrating a sequence of operations performed to create a service provider account with the service referenced in FIG. 1.

FIG. 3 is a flowchart illustrating a sequence of operations performed to add a matter to the service referenced in FIG. 1.

FIG. 4 is a flowchart illustrating a sequence of operations performed to create a client account with the service referenced in FIG. 1.

FIG. 5 is a flowchart illustrating a sequence of operations performed to access a web-based service provider accounting system using the service referenced in FIG. 1.

FIG. 6 is a flowchart illustrating a sequence of operations performed by an adapter to access a standalone service provider accounting system and interface with the service referenced in FIG. 1.

FIGS. 7-11 illustrate example displays capable of being generated and presented to a service provider user accessing the service referenced in FIG. 1.

FIGS. 12-17 illustrate example displays capable of being generated and presented to a client user accessing the service referenced in FIG. 1.

FIG. 18 is a flowchart illustrating a sequence of operations performed to generate a data representation using the service referenced in FIG. 1.

### DETAILED DESCRIPTION

Embodiments consistent with the invention provide secure client access to pre-billed time information from a service provider accounting system. By doing so, a client is able to view pre-billed time information, such as time entries for a service provider's timekeepers that have been entered into a service provider accounting system, prior to those time entries being billed to the client.

Pre-billed time information, in this regard, may include various types of timekeeping-related information that may be stored and/or calculated by an accounting system used by a service provider, and that is associated with work performed by the service provider on behalf of the client, and in particular, work performed by one or more timekeepers that is associated with a service provider and has not yet been billed or invoiced by that service provider. For example, pre-billed time information may include information such as time entries, and in particular, unbilled time entries (including one or more of a timekeeper identifier, code and/or name; a date; a time; a duration; a billing rate; a cost or charge amount; a project or matter; a client; a narrative, description, task, note, or other descriptive information; a charge code; a billing phase; a task code; a timekeeper billing level, etc. In addition, any or all of the information in the time entries may be combined and/or manipulated, e.g., to provide different visualizations of pre-billed time information, e.g., costs and/or time spent on a particular matter or project, costs and/or time spent by a particular timekeeper, costs and/or time spent on a particular day or range of days, etc. Other types of pre-billed time information include project budgets, standard or fixed charges, etc. Such information is “pre-billed” to the extent that the work associated with the information and performed by a timekeeper has not yet been billed by a service provider, which in many circumstances is work for which an invoice has not yet been finalized and/or sent to a client for payment.

In addition, in some embodiments it may be desirable to provide other pre-billed information in addition to pre-billed time information. For example, various expenses such as travel costs, postage, government filing fees, copying charges, and other reimbursable, out-of-pocket expenses, which have not yet been invoiced to a client (collectively referred to herein as “pre-billed expense information”), may also be shared with a client through a similar mechanism to that used for pre-billed time information.

It will also be appreciated that a pre-billed time information service may provide client access to additional information from a service provider accounting system, e.g., invoices, payments, timekeeper information, post-bill time information (e.g., time entries that have already been billed), matter or project information, service provider information, client information, etc. In some embodiments, for example, a pre-billed time information service may be integrated into an accounting system or service, e.g., a service provider's accounting system or an accounting system or service that supports multiple service providers.

A service provider, within the context of the invention, may include practically any individual, group of individuals or legal entity that provides services, to a client, typically for a fee. Typically, this fee is based at least in part on the amount of time expended by one or more timekeepers in performing the services, although it will be appreciated that a service provider may also utilize other billing arrangements for services. A client, in turn, may include practically any individual, group of individuals or legal entity that receives services from a service provider, or any individual, group of individuals or legal entities that have been authorized by someone who receives services from the service provider, e.g., an auditor or other third party. A non-limiting list of example service providers includes accountants, actuaries, appraisers, architects, lawyers or attorneys, paralegals, contractors, consultants, business development managers, copywriters, engineers, funeral directors, public relations professionals, recruiters, researchers, real estate brokers, translators, doctors and other medical professionals, or any other hourly billers, as well as legal entities (e.g., partnerships, firms, corporations, etc.) employing individuals practicing such professions.

In addition, a timekeeper within the context of the invention may include any individual that performs work for which time information is entered into an accounting system. A timekeeper consistent with the invention may include any of the individuals mentioned above as service providers, as well as any additional support staff utilized by such service providers (e.g., for a law firm, individuals such as paralegals, litigation support personnel, etc.).

Other variations and modifications will be apparent to one of ordinary skill in the art having the benefit of the instant disclosure.

### Hardware and Software Environment

Now turning to the Drawings, wherein like numbers denote like parts throughout the several views, FIG. 1 illustrates an example apparatus 50 suitable for implementing a pre-bill time information service consistent with the invention. For the purposes of the invention, computer 50 may represent practically any type of computer, computer system or other programmable electronic device. Moreover, computer 50 may be implemented using one or more networked computers, e.g., in a cluster or other distributed computing system, or may be implemented within a single computer or other programmable electronic device, e.g., a desktop computer, laptop computer, handheld computer, cell phone, set top box, etc.

Computer 50 typically includes a central processing unit 52 including at least one microprocessor coupled to a memory 54, which may represent the random access memory (RAM) devices comprising the main storage of computer 50, as well as any supplemental levels of memory, e.g., cache memories, non-volatile or backup memories (e.g., programmable or flash memories), read-only memories, etc. In addition, memory 54 may be considered to include memory storage physically located elsewhere in computer 50, e.g., any cache memory in a processor in CPU 52, as well as any storage capacity used as a virtual memory, e.g., as stored on a mass storage device 56 or on another computer coupled to computer 50. Computer 50 also typically receives a number of inputs and outputs for communicating information externally. For interface with a user or operator, computer 50 typically includes a user interface 58 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 50 may also include one or more mass storage devices 56, e.g., a floppy or other removable disk drive, a hard disk drive, a direct access storage device (DASD), an optical drive (e.g., a CD drive, a DVD drive, etc.), and/or a tape drive, among others. Furthermore, computer 50 may include an interface 60 with one or more networks 62 (e.g., a LAN, a WAN, a wireless network, and/or the Internet, among others) to permit the communication of information with other computers and electronic devices, e.g., one or more user computers 64, one or more web-based service provider accounting systems 66 and one or more standalone service provider accounting systems 68. It should be appreciated that computer 50 typically includes suitable analog and/or digital interfaces between CPU 52 and each of components 54, 56, 58 and 60 as is well known in the art. Other hardware environments are contemplated within the context of the invention.

Computer 50 operates under the control of an operating system 70 and executes or otherwise relies upon various computer software applications, components, programs, objects, modules, data structures, etc., as will be described in greater detail below. Moreover, various applications, components, programs, objects, modules, etc. may also execute on one or more processors in another computer coupled to computer 50 via network 62, e.g., in a distributed or client-server computing environment, whereby the processing required to implement the functions of a computer program may be allocated to multiple computers over a network.

As an example, computer 50 may include a web server 72 incorporating a pre-billed time information service 74 used to provide client access to pre-billed time information from one or more service providers. As will become more apparent below, service 74 may be integrated within an accounting system, or in the alternative, may be interfaced with one or more accounting systems located locally in computer 50 or in an external system. For example, service 74 may interface with a web-based service provider accounting system 66, e.g. using an Application Programming Interface (API) 76 provided by accounting system 66, or may interface with a standalone service provider accounting system 68, e.g. using an adapter 78 integrated into other otherwise in communication with system 68. In addition, service 74 may manage a pre-billed time information database 80 that stores the pre-billed time information retrieved from one or more accounting systems as well as other accounting, client and service provider information.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, tangible storage media such as volatile and non-volatile memory devices, floppy and other removable disks, hard disk drives, magnetic tape, optical disks (e.g., CD-ROMs, DVDs, etc.), among others, and transmission media such as digital and analog communication links.

In addition, various program code described herein may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

### Pre-Billed Time Information Service

Embodiments consistent with the invention implement a pre-billed time information service that permits clients to securely access pre-billed time information from one or more service providers. In the illustrated embodiment discussed hereinafter, a pre-billed time information service is implemented as a web-based service, and within a web server environment, that integrates with external accounting systems and/or accounting services associated with multiple service providers, and utilizes client authentication to ensure that only those clients having appropriate authorization can access pre-billed time information for the projects or matters for which those clients are authorized.

As illustrated in FIG. 1, for example, a pre-billed time information service 74 may be integrated in a web server 72 and interfaced with multiple web-based service provider accounting systems or services 66, as well as multiple standalone service provider accounting systems or services 68. It has been found that most service providers utilize one of these types of accounting systems, so providing support for both types of systems enables a wide variety of service providers to provide their clients with access to pre-billed time information using the herein-described service. It will be appreciated, however, that the herein-described service may be interfaced with other types of accounting, billing or timekeeping systems, so the invention is not limited to the particular types of accounting systems disclosed herein.

For web-based service provider accounting systems 66, these system are typically cloud-based and support multiple service providers. In the illustrated embodiment, an API 76 exposed by the accounting system is used to interface service 74 with a particular service provider's accounting and billing information, e.g., using a public API with OAuth authentication. OAuth is an open source authentication protocol that in part enables end-users to authorize third-party access to their server resources without sharing their credentials (e.g., a username and password pair), using user-agent redirections. Other third-party authentication frameworks may be used to authorize service 74 access to the service provider's accounting and billing information. As will become more apparent below, a service provider establishes a user account with pre-billed time information service 74, and in the course of establishing that account, authorizes service 74 to access that service provider's pre-billed time information managed by its associated web-based service provider accounting system 66. It will be appreciated that other authentication protocols and methodologies may be utilized to provide service 74 with access to the relevant pre-billed time information stored in a web-based service provider accounting system, and as such, the invention is not limited to the use of an API with OAuth authentication.

Standalone service provider accounting systems 68, on the other hand, are typically installed on a server running on a service provider's private network, typically behind a firewall, and typically utilize a client-server architecture. While in some embodiments, service 74 may interact with a standalone system through a remote access portal, a VPN, or another remote access protocol, in the illustrated embodiment it may be desirable to utilize software installed behind the firewall on the service provider's private network to access the accounting system 68 and to interact with service 74. In one embodiment, for example, an adapter 78 may be installed on the private network, e.g., in a physical or virtual server running on the same or a different physical machine from that upon which the accounting system runs. The adapter may be provided with access rights to the accounting system, e.g., by setting up a dedicated database user in the accounting system and configuring the adapter to log into the accounting system using that database user's credentials. For data security, it may be desirable to provide the database user with read-only privileges, and to provide privileges to only a portion of the data in the accounting system. Alternatively, the adapter may be configured as a plug-in to the accounting system, or in other manners that would be apparent to one of ordinary skill in the art having the benefit of the instant disclosure. Irrespective of how the adapter integrates with the accounting system, however, the adapter is configured to issue queries to the accounting system and push the results to service 74, as will be discussed in greater detail below.

In addition, as shown in FIG. 1, service 74 may also interact with one or more user computers or devices 64. The users of service 74 may include both clients and service providers, and in the illustrated embodiments, various types of user devices 64 may be supported, including, for example, desktop computers, laptop computers, mobile phones, tablets, etc. Interaction with each device 64 may be through a web-based interface, e.g., using a desktop or mobile web browser installed on a device 64, or alternatively using a dedicated desktop or mobile application (app) 80 installed on the device. Interaction may be implemented using web-based protocols, or alternatively, based on proprietary protocols between the service and any dedicated applications, and it is typically desirable to support multiple types of devices and access methods to provide greater availability to different types of users. Various technologies for enabling user devices to interact with service 74 will be appreciated by one of ordinary skill in the art having the benefit of the instant disclosure.

Now turning to FIG. 2, this figure illustrates at 100 a sequence of operations that may be used by a service provider to create an account with pre-billed time information service 74. For this embodiment, it is assumed that a web-based protocol is used, whereby interaction between a user and the service is handled through a web-based interface. For other types of devices, alternative interactions may be supported.

For example, starting in block 102, a user associated with a service provider may create a service provider account, e.g., by selecting a “sign up” user control provided on a home page for the service and identifying the account type as a service provider type. The user, e.g., an accountant, administrator or other responsible party for a service provider, may enter account information such as a username, password, email address and the user's first and last name. In addition, the user may be required to assent to terms of service.

Next, in block 104, the individual enters information about the service provider, e.g., service provider name, mailing address, phone number, and demographic information such as number of employees and industry group. Next, in block 106, the service provider's accounting system is selected from a list of supported accounting systems. Then, in block 108, it is determined whether the selected accounting system is a web-based accounting system. If so, control passes to block 110, where the user authenticates with the web-based accounting system using OAuth. For example, service 74 may contact the web-based accounting system through a public API and request authentication using the user's email address. The user is requested to approve or deny the authentication request, and once approved, service 74 is granted access to the service provider's account in the web-based accounting system.

Returning to block 108, if the selected accounting system is a standalone accounting system, control passes to block 112, where the user is prompted to download and install the adapter software. For example, the user may be presented with a link enabling the software to be downloaded, which the user has the option to forward to IT personnel to handle the installation if so desired. In addition, at this time the user may be presented with a unique API key that may be entered in the adapter during the installation process to authorize connections with service 74.

In one embodiment, for example, the adapter is implemented as a .net console application that communicates with service 74 via an API server over an HTTPS connection. To interface with the accounting system, a database user may be created in the accounting system with SELECT (read-only) privileges only, with an appropriate connection stream added to a configuration file for the adapter. The adapter is configured to issue queries to the accounting system to obtain a list of matters, as well as to retrieve pre-billed time information and other accounting information from selected matters. In this embodiment, the adapter is configured to periodically run a set of queries to retrieve the pre-billed time information and any other accounting information for selected matters and push the results to service 74, with the period between pushes set to balance the currency of the data with the load on the system. Implementation of an adapter meeting the aforementioned characteristics would be well within the abilities of one of ordinary skill in the art having the benefit of the instant disclosure.

Upon completion of block 110 or block 112, block 114 then confirms the user's email address, typically by sending an email to the user's email address containing a link that uniquely identifies the user. When the user clicks on the link in the email address, the service recognizes the link as being associated with the confirmation email, and confirms the user's email address.

Next, in block 116 the user optionally selects a subscription. For example, different tiers of service may be supported, with different costs (e.g., monthly fees) associated with the different tiers. The tiers may be distinguished, for example, based upon the number of clients and/or matters to be monitored, and a free tier of service may be provided in some embodiments, as may a limited-time free trial. At this point, the user may also be prompted to enter payment information such as a credit card number, or may be prompted to access a third party payment service.

Next, in blocks 118 and 120, the user adds matters and clients. Adding matters to the service, which is described in greater detail below in connection with FIG. 3, authorizes the service to access pre-billed time information and other accounting information related to those matters or projects. Adding clients to the service authorizes users associated with clients to access the service. In one embodiment, a client may be added through the use of email invites. As such, a user may be prompted to enter a first and last name and email address of a client, resulting in the generation of an invite email that is sent to the specified email address. The invite email includes a unique link that enables the client to either sign in (if already registered with an account) or sign up to create a new account, and by virtue of the link being unique, the service is able to link the client to the service provider. In some embodiments, a batch process may be supported whereby the user provides the service with a list of clients (e.g., a CSV file with a first name, last name, and email address for each client) such that email invites may be sent to multiple clients at the same time, and without requiring a user to manually input the information for each client.

Once matters and clients are added, in block 122 the user links the added clients to the added matters, and in block 124 the user configures the clients' rights to those matters. For example, a user may be provided with a list of matters and user controls that enable the user to select one or more matters to be linked to each added client. In addition, for each client, a set of permissions may be configured for that client, e.g., to control whether a client is able to view billing rates, timekeeper identifiers, task information or notes associated with time entries.

It will be appreciated that the order in which the various steps illustrated in FIG. 2 are performed may vary in different embodiments, and that certain operations (e.g., installing an adapter) may occur outside of the flow 118. Thus, the invention is not limited to the particular flow illustrated in FIG. 2.

FIG. 3 illustrates the sequence of operations associated with adding matters in greater detail. In particular, as illustrated at block 130, the manner in which matters are added varies depending upon whether the service provider accounting system is web-based or standalone. If web-based, control passes to block 132 to access the web-based accounting system API to retrieve a list of available matters in the service provider accounting data. In some embodiments, all available matters may be entered, or in the alternative, the user may be prompted to enter a client name or identifier, or other criteria to limit what matters are returned. Next, in block 134 the returned matters are displayed in a list, and the user selects those matters to add in block 136. Thereafter, in block 138 the user identifies a billing partner (or other responsible individual) for each added matter. The billing partner is an individual to whom client inquiries are directed whenever a client has a concern with respect to a particular matter. In some embodiments, if the billing partner does not currently have an account with the service, the billing partner may be added as a new user (block 140). Alternatively, the billing partner may not be required to have an account, and may simply be identified by an email address so that inquiries can be emailed to that individual outside of the service.

Returning to block 130, if the service provider accounting system is a standalone system, control instead passes to block 142 where the user is prompted to enter a list of matters to be added (or any other suitable search criteria that identifies the relevant matters, such as a client name or identifier if all client matters are to be added). Control then passes to block 138 to choose a billing partner for each matter. As will be discussed in greater detail below, the list of matters entered in block 142 is communicated to the adapter the next time the adapter connects to service 74 to enable the adapter to query for matter information and retrieve accounting and pre-bill time information for each of those matters. In other embodiments, however, a list of matters may be retrieved and presented to a user in a similar manner to that for a web-based accounting system.

Now turning to FIG. 4, this figure illustrates at 150 a sequence of operations that may be used by a client to create an account with pre-billed time information service 74. This sequence of operations may be initiated either in response to the client visiting the service web site, or alternatively, in response to the client clicking on a link in an invite email from a service provider. For example, starting in block 152, a user associated with a client may create a client account, e.g., by selecting a “sign up” user control provided on a home page for the service and identifying the account type as a client type. The user may then enter account information such as a username, password, email address and the user's first and last name. In addition, the user may be required to assent to terms of service. Next, in block 154, the user's email address is confirmed, typically by sending an email to the user's email address containing a link that uniquely identifies the user. When the user clicks on the link in the email address, the service recognizes the link as being associated with the confirmation email, and confirms the user's email address. Of note, since the service provider is responsible for setting up the service provider accounting system, the client sign up process is typically less involved.

Once both a client and a service provider are registered with the service, and the client is linked to one or more matters, the client may be provided with pre-bill time information and other accounting information in a real-time basis. By “real-time” what is meant is that the client is provided with relatively up-to-date information as is stored in the service provider's accounting system, depending upon how frequently the information is retrieved from the service provider accounting system. For example, it may be desirable for an accounting system to be queried on a regular, periodic basis, such as once per day, multiple times per day, once per hour, multiple times per hour, or another suitable interval. “Real time” may also be dependent upon the frequency at which a service provider's accounting system is updated. Alternatively, the accounting system may be queried on demand, i.e., in response to a client logging in to the service and/or attempting to retrieve information for a particular matter.

The manner in which information from a service provider accounting system is obtained by a pre-billed time information service may vary in different embodiments. For example, FIG. 5 illustrates an example routine 160 executed by service 74 to access a web-based service provider accounting system. Routine 160 accesses the accounting system periodically, and as such, begins in block 162 by waiting for a next connection interval. Next, in block 164, a connection is established with the accounting system, and in block 166, a query is made through the accounting system API to retrieve a list of matters for the client. Next, in block 168, a query is made through the accounting system API to retrieve client and matter information, and in block 170, a query is made to retrieve invoices for all client matters. Then, in block 172, time entries for all client matters are retrieved.

The information retrieved in blocks 166-172 is then used to update the client data stored in service 74, i.e., to synchronize the information stored by service 74 with the information stored in the accounting system, before returning to block 162. For example, the list of matters returned from the accounting system may include any matters added to the accounting system since the last connection, as well as any matters added by a user via service 74, such that the service may be updated with a correct list of matters of interest for a client. New invoices may be added and existing invoices may be updated to a new status (e.g., transitioning from outstanding to paid in response to a payment made by a client), and new time entries may be added and existing time entries may be modified or updated to a new status (e.g., from unbilled, to billed, to collected).

It will be appreciated that the queries issued to the accounting system may be constrained to minimize the effort required to synchronize the service with the accounting system. For example, queries may be limited to a specific time period (e.g., the last 90 days). In addition, queries may be limited to subsets of invoices or time entries, e.g., to exclude invoices or billed entries older than a certain time frame, or to specific matters that have already been added to the service.

FIG. 6 next illustrates an example routine 200 executed by an adapter 78 installed on a service provider network to access a standalone service provider accounting system. Routine 200 accesses the accounting system periodically, and as such, begins in block 202 by waiting for a next connection interval. Next, in block 204, a connection is established with the pre-billed time information service 74, by authenticating through the service API (represented by block 206). Next, in block 208, the adapter requests a list of matters from service 74 (which is returned in block 210). Next, in block 212, a query is made to the standalone accounting system to retrieve client and matter information for the matters in the returned list (which is returned in block 214), and in block 216, the client and matter information is pushed to service 74, and used to update the client and matter information stored in the service (block 218). Next, in block 220, the adapter makes a query to the accounting system to retrieve invoices for all client matters (which are returned in block 222). The returned invoices are then pushed to the service in block 224, such that the client invoices stored in the service may be updated with the new information (block 226). Then, in block 228, time entries for all client matters are retrieved via a query to the standalone accounting system (which are returned in block 230). The returned time entries are pushed to service 74 in block 232, and used to update the time entries stored in the service (block 234. Adapter 78 then terminates the connection with service 74 in block 236, and returns to block 202 to await a next connection interval.

FIGS. 7-11 illustrate an example series of displays that may be generated and presented to a service provider accessing service 74. The displays are generated as HTML-compatible web pages that are viewable on a desktop or laptop browser, although it will be appreciated that for other types of devices, such as mobile devices and tablets, different displays may be generated to optimize the presentation of information and interaction with a user for those particular devices.

FIG. 7, for example, illustrates an example dashboard display 300 initially presented to a user that signs into service 74 and having the role of a service provider. The display may include, for example, controls 302, 304 to add new matters and people (e.g., clients) to the service provider's account, which respectively invoke the add matter and add client functionality described above in connection with FIGS. 2-3. Messages and other pending issues may also be presented to the user on this display. In addition, a series of controls 306, 308, 310, 312 and 314 are provided in a menu bar format and desirably displayed at the top of every display presented to the user. A dashboard control 306 enables the user to return to dashboard display 300, while matter and people controls 308, 310 enable a user to view and manage matters and people, respectively. A request control 312 may open a dialog box or popup window showing the status of sent and received requests or messages, and enabling the user to confirm or cancel requests, or open the requests in a separate display. Requests may include, for example, messages to and from clients, service 74 information and client invites, among other types of requests. A user control 314 displays the user's identifier and when selected opens a menu enabling the user to change settings, provide feedback to service 74 or sign out.

FIG. 8 illustrates an example matters display 320 generated in response to selection of matter control 308, which displays a list of active matter entries 322, including information such as the matter name or other identifier, the date added to the service, a name and contact for the billing partner assigned to the matter, and the number of current users subscribed to the matter, as well as the number of inactive users (e.g., users that have been invited to subscribe but have not yet responded, or users that have been excluded from viewing the matter). In addition, various matter management controls 322-330 may be provided, e.g., an add matter control 324 that invokes the add matter functionality described above in connection with FIGS. 2-3, a delete matter control 326 that allows a user to delete or remove any selected matters, an actions control 328 that allows a user to perform additional actions on any selected matters, e.g., adding users or changing the billing partner, and a search control 330 that enables the list of matters to be filtered based upon a search criterion, e.g., to limit to particular clients (engagements) or particular matters.

Upon selection of a matter entry 322, a matter management display such as display 340 of FIG. 9 may be displayed to the user. In this display, a list 342 of current users 344 subscribed to the matter is displayed, along with a series of permission controls 346-352 that control what information is viewable by the associated user. Rate control 346 controls whether the user is able to view timekeeper rate information, while timekeeper 348 controls whether the user is able to view the identity of the timekeeper(s) working on the matter. Task control 350 controls whether the user is able to view the task information in the time entries for the matter, and similarly notes control 352 controls whether the user is able to view any notes attached to any time entries for the matter.

Display 340 also enables a service provider user to de-activate a particular user through selection of a stop sharing control 354, which has the effect of moving the user from current user list 342 to inactive user list 356, and disabling that user's access to the matter. Likewise, additional users may be subscribed to the matter using an add user control 358, which invokes the add user functionality discussed above in connection with FIG. 2, and which initially adds the user to the inactive user list 356 until the added user accepts the invitation.

It may also be desirable in some embodiments to provide a permissions template 360 for each matter that enables a set of default permissions to be assigned to new users. Furthermore, to provide additional control over what information is viewable by users subscribed to a matter, a filter control 362 may be used to hide notes in any time entries associated with a matter that include particular keywords. Thus, for example, timekeepers may be instructed to add a keyword such as “TEMP” or “HIDE” or “DRAFT” to time entries that are not in a suitable condition to display to a client, and if the corresponding keyword is added to control 362, those notes will not be displayed to a client user of the service. Otherwise, permissions and keywords may be used to restrict the information that is viewable by clients to comply with service provider and/or client policies. Also, in some embodiments, keywords may be assigned at the engagement level such that notes including particular keywords will be hidden for all matters associated with a particular combination of service provider and client user.

FIG. 10 next illustrates an example people management display 370 that is displayed in response to user selection of people control 310. Display 372 includes a list 372 of client user entries 374, each associated with a client user, and each providing information such as name, email, associated client/company, phone number, date added, and statistics regarding the number of matters the user is subscribed to, pending a subscription, and excluded from viewing. Additional statistics regarding the number of client users may be provided at 376 (e.g., total numbers, number of active users, number of inactive users, number of users pending/awaiting confirmation, etc.). Similar statistics may be provided for billing partners 378 (e.g., total number, number assigned to matters, and number unassigned to any matters). In addition, it may be desirable to provide a list of the billing partners in display 370, e.g., in another section of the display, and to include management functionality in a similar manner to that used for client users. For example, for client users, it may be desirable to include an add client user control 380 to add additional client users, a search control 382 to enable the list 372 of client users to be filtered, e.g., by name or email address. An additional actions control 384 may also be provided to invoke additional actions, e.g., removing client users from the service provider's account.

Upon selection of a client user entry 374, a client user management display such as display 390 of FIG. 11 may be displayed to the user. In this display, a list of client user entries 392 is provided, displaying both the status and the date added to service 74, as well as a set of permission controls 394 enabling the client user's permissions to the matter to be reconfigured. Additional controls, e.g., an add to matters control 396 that enables the client user to be added to other matters (which may result in the display of a dialog box listing available matters and an ability to search for particular matters among the displayed available matters) as well as a group actions control 398 that enables actions such as starting and stopping sharing by the client user to be performed for one or more matters.

It will therefore be appreciated that in the illustrated embodiment, a service provider, and in particular a user associated with that service provider (who may have the role of a service provider administrator), has primary responsibility for controlling and managing access by clients and client users to the service provider's accounting and pre-billed time information. Moreover, client users typically are required to request access to matters or changes in permissions to enable a service provider to control what information is accessible to what clients and users. In addition, in some embodiments a service provider is permitted to establish a “team” of service provider users, including multiple billing partners, and appropriate access controls may be used to restrict what information may be viewed and/or modified by those various users.

Similarly, in some embodiments it may be desirable to enable a client to utilize a team concept such that multiple client users can be provided with various access rights to different types of information. In one embodiment, for example, different level accounts may be supported for individuals and organizations, such that a client user account may be upgraded to support an entire company or other organization. One client user may be designated an organization administrator with the ability to manage a team of subordinates, their access to specific matters, and their permissions on those matters. Since it is typically desirable for a service provider to maintain overall control over access rights and permissions, however, in some embodiments the access control management performed by an organization administrator may only further limit access rights by subordinate users from those granted to the organization by a service provider (e.g., if an organization is only permitted to access matters A & B, and only view task and notes information but not timekeeper or rate information, an organization administrator would typically be permitted to limit a particular user to view only matter A, or view only notes information, but would typically not be permitted to allow a particular user to view matter C or view timekeeper or rate information.

In addition, in some embodiments where organization accounts are supported, it may be desirable to shift the management of individual client users from the service provider to the organization administrator, and in some instances hide those client users from the service provider altogether. Thus, for example, if service provider A connects with Company X (client) to share matters, the administrator for service provider A may not even see all of the people that the Company X administrator has invited and added to particular matters. Permissions and rights to particular matters for client users would be inherited from the Company X access rights, with further limitations established by the Company X administrator as desired. From the standpoint of the service provider, however, the client would be managed as a single client user.

FIGS. 12-17 illustrate an example series of displays that may be generated and presented to a client accessing service 74. FIG. 12, for example, illustrates an example dashboard display 400 initially presented to a user that signs into service 74 and having the role of a client. The display may include, for example, a series of controls 402, 404, 406, 408 and 410 provided in a menu bar format and desirably displayed at the top of every display presented to the user. It will be appreciated that a control consistent with the invention may include various types of user interface elements through which a user can request that a particular operation be performed. In some embodiments, e.g., in web-based environments, controls may be implemented as hyperlinks or other user interface elements supported by HTML and other web-based technologies. Controls may also be implemented using user interface elements supported by an application, a mobile application, or an underlying operating system. Other control implementations will be appreciated by one of ordinary skill in the art having the benefit of the instant disclosure.

An engagements control 402 generates a menu that includes options enabling the user to return to dashboard display 400, to view all of the client's matters, or to view selected “engagements,” i.e., service providers from which the client receives services. Thus, for example, one client may have multiple engagements with multiple service providers and manage the pre-billed time information associated with these multiple engagements from a single, integrated service.

A messages control 404 navigates the user to a display of the messages sent to and received by the client user, and may include various types of messaging-related functionality that would be apparent to one of ordinary skill in the art, including for example message contents, message types (e.g., invitations, queries, instructions, requests), when messages are sent and/or received, message senders and/or recipients, message status, etc. Messages may be internally managed by service 74, or alternatively, emails or other external messaging functionality may be used to enable communication between clients and service providers.

A request control 406 may open a dialog box or popup window showing the status of sent and received requests or messages, and enabling the user to confirm or cancel requests, or open the requests in a separate display. Requests may include, for example, messages to and from clients, service 74 information and client invites, among other types of requests. In addition, request control 406 may also include an option to connect with a new service provider, enabling a user to input a service provider's name, email address and any additional text to send an invite email to request that the service provider establish an account with service 74, in a similar manner to the aforementioned manner in which service providers may invite clients to establish an account with the service.

A search control 408 opens a search dialog that enables a client user to display pre-billed time information meeting a particular search criteria (discussed in greater detail below in connection with FIG. 17). In addition, a user control 410 displays the user's identifier and when selected opens a menu enabling the user to change settings, provide feedback to service 74 or sign out.

Dashboard display 400 also includes a data presentation 412 reporting various statistics about pre-billed time and other accounting information maintained by service 74. For example, the total hours entered over a predetermined time period along with a calculated cost of those hours may be displayed as represented by indicators 414 and 416. In addition, a graphical or other representation of daily hours entered or the value thereof over the predetermined time period may be displayed as represented by bar graph 418. In addition, the bars on the bar graph may be selectable by the user to invoke a search that displays a similar data presentation for the selected day, and showing a list of time entries for that day along with any other potentially relevant information. It will be appreciated that the same data presentation or visualization may be used to display various types of pre-billed time information. For example, the same presentation format may be used to show the pre-billed time information for a client across all engagements, for a selected engagement, for a selected matter or group of matters, or for any other collection of time entries meeting a particular search criterion.

The time period over which to calculate the data may be controlled by the client user, e.g., through selecting a time period via a time period control 420 (shown with “current month,” “7 days,” “30 days,” and “90 days” options). Alternative controls, e.g., calendar controls enabling the input of start and end dates, may be used in the alternative.

Below presentation 412 is typically displayed a list 422 of entries for the client's engagements, along with statistics such as number of time entries and total hours entered for each engagement. Additional information, such as system notifications 424 (e.g., messages or helpful tips from service 74) may also be displayed. Further, a “conference room” display 426 is provided to highlight recent messages to and from various service providers, as well as other activities occurring with respect to various service providers. In one embodiment, for example, it may be desirable to display entries notifying the client user of when new invoices have been received and when payment has been received for existing invoices, as well as entries related to account updates, responses, notifications of new matters, etc.

Selection of an engagement entry from list 422 results in the generation of an engagement display such as display 430 of FIG. 13. Similar to display 400, display 430 includes a data presentation 432 reporting various statistics about pre-billed time and other accounting information maintained by service 74, but limited to the selected engagement. For example, the total hours entered over a predetermined time period for the engagement along with a calculated cost of those hours may be displayed as represented by indicators 434 and 436. In addition, a graphical or other representation of daily hours entered or the value thereof over the predetermined time period and for the selected engagement may be displayed as represented by bar graph 438. In addition, where invoicing information is available from a service provider accounting system, a balance due may also be displayed via indicator 440. In addition, the time period over which to calculate the data may be controlled by the client user using a time period control 442 similar to time period control 420 of FIG. 12.

Below visualization 432 is displayed a list 444 of matter entries, each including a matter name, a number of time entries, and a total hours entered from that matter. In addition, a “pencils down” control 446 may be used to send an email or other electronic communication to the matter's assigned billing partner requesting that the service provider immediately stop work on this matter. Thus, a client is able to quickly and easily notify a service provider whenever work should be stopped on a particular matter, thereby reducing the possibility that a service provider will continue to do work on a project after the client has indicated a desire to stop work. For example, if a client notices that too much time is being spent on a project, the client can quickly halt work on the project and contact the service provider to discuss how to proceed going forward.

A billing partner control 448 generates a popup with contact information for the billing partner assigned to the matter. In addition, a request matters control 450 opens a dialog box that permits a user to enter text for a message that is sent to the service provider to request that the service provider add or remove the client user to or from one or more matters, or to change the access permissions for that client user. In the illustrated embodiment, the service provider ultimately controls which clients and client users have access to what matters, so rather than enabling a client user to add a matter, a request is sent to the service provider so that a service provider user can add the client user to the matter if appropriate.

FIG. 14 next illustrates engagement display 430 after user selection of a matter entry from list 444, which opens a list 452 of time entries 454, including all of the pre-billed time entries entered by timekeepers for the service provider over the predetermined time period selected by the user. Each entry 454 may include, for example, the date of the entry, the timekeeper associated with the entry, an amount of time, a billing rate for the timekeeper, and a cost for the entry (typically, the product of the billing rate and the amount of time). In addition, each time entry includes a task and notes entered by the timekeeper to describe the activities that were performed by the timekeeper on the project. It will be appreciated that the information associated with a time entry may vary in different embodiments. For example, some time entries may be associated with particular accounting codes or other classifiers. Some time entries may include only a single narrative describing the entry, rather than separate task and notes fields. Some time entries may include fixed fees, standard fees, reduced billing rates, etc., and as such, the display of each time entry may be configured to display whatever relevant information exists for a time entry. Other variations will be apparent to one of ordinary skill in the art having the benefit of the instant disclosure.

In addition, it will be appreciated that the display of time entries may be modified based upon any permissions or filters set by the service provider. As noted above, client users may have permissions set or disabled that selectively display or hide the timekeeper, the billing rate, the task information and/or the notes information. In addition, keywords may be specified that, when present in the notes field, cause the notes field to be hidden from the client.

Each entry 454 may also include an information control 456 that displays a pop-up with additional information about the time entry (e.g., the date added to service 74). In addition, a query control 458 may be used to send a question to the service provider about the entry. The question may be sent, for example, as an email, and the response to that question may be provided via an email or through an internal message sent by the service provider in response to the question. In one embodiment, the email includes the time entry information along with a link that when clicked confirms receipt to the client and indicates that the service provider will follow up as soon as possible, and a link that asks the client to follow up directly. Other links may be provided in other embodiments, with a goal being to make it as easy as possible for the service provider to promptly respond to a question about a time entry.

FIG. 15 next illustrates a my matters display 460 that may be generated, for example, in response to user selection of a “my matters” option in the menu displayed by engagements control 402. Display 460 includes a list 462 of matter entries 464, optionally sorted and grouped by engagement. Each entry 464 includes a matter name, a billing partner and the permissions 466 assigned to that client user for that matter. Given that the service provider manages the permissions in the illustrated embodiment, the displayed permissions 466 are read-only.

Upon selection of the matter entry, the client user may be presented with a matter display that is similar to engagement display 430, but limited to the selected matter. Thus, the data visualization and list of time entries will be limited to those time entries associated with the selected matter.

In addition, each matter entry 464 includes an matter visibility control 468 that, when selected, toggles between including and excluding the matter in and from any displays of recent activity. Thus, if a client user wishes to view engagement level pre-billed time information for only a selected set of matters, control 468 may be used to selectively exclude matters that are not of interest. Display 460 may also include a matter request control 470 that functions in the same manner as control 450 discussed above in connection with FIG. 13.

FIG. 16 illustrates a search results display 480 that includes search results 482 meeting a particular search criterion entered in a dialog box 484. Dialog box may be displayed, for example, in response to selection of search control 408, and may include any number of different controls suitable for entering a search criterion. In the illustrated embodiment, for example, calendar controls may be used to enter starting and ending dates, and an engagement control may be used to limit the search to a particular engagement. A filter control may be used to enter keywords or other filter criteria to further limit the search results. The filter criteria may search all information in a time entry, or may be restricted to particular fields, e.g., task, notes, timekeeper, amount of time, cost, etc. Practically any search criterion that limits what time entries are returned as search results may be used. In addition, as shown at 482, the search results may include a similar data presentation as is used for displays 400 and 430.

FIG. 17 next illustrates a settings display 490 that may be used to configure alerts and notifications for a client user. Display 490 may be presented to a client user, for example, in response to selection of a settings control in the menu displayed by control 410, or alternatively, in response to selection of a system notification 424 in display 400 of FIG. 12. In some embodiments, a client user is able to control whether or not the client user receives periodic notifications of activity. Control 492, for example, enables a client user to select no notifications, daily notifications or weekly notifications. The periodic notifications can take the form of emails that include all of the time entries entered for all of the client's matters since the last notification email, or in the alternative, may simply include summaries of total entries, total cost, total hours, etc., and segregated by engagement and/or matter, along with a link enabling the client user to sign in to service 74 to view additional details.

Also, in some embodiments a client user is able to set one or more activity alerts using control 494. For example, a client user can specify a particular matter or engagement, along with an alert criterion (e.g., total dollars, total hours, dollars since beginning of month, hours since beginning of month) and a threshold amount that, when exceeded according to alert criterion, triggers an alert to the client user. The client user may also be able to select from among multiple notification options, e.g., an email or a text message (push).

FIG. 18 next illustrates at 500 a sequence of operations performed by service 74 to generate a display of pre-billed time information for a client user, e.g., a display similar to displays 400, 430 and 480. First, at block 502 a search is performed on the pre-billed time information stored by service 74 based on a search criterion. As noted above, the search criterion may be entered by a client user (e.g., as with display 480), or alternative, for certain visualizations, such as at the engagement level (e.g., as with display 400), at the matter level (e.g., as with display 430), at the daily level, etc., the search criterion is essentially set by the service.

Next, in block 504, time entries that a client user is not permitted to access are filtered from the search results. For example, time entries associated with matters that the client user is not currently subscribed to are excluded from the results. Then, in block 506, the time entry data is aggregated to generate total hours and costs for display in a data presentation. Next, in block 508, a bar graph visualization is generated including bars corresponding to the total hours (or alternatively) costs associated each day within the relevant time period. In addition, the bars may be generated as selectable HTML elements to enable a client user to view additional information about a particular day by selecting an associated bar. Next, in block 510 a data representation is generated including the aggregated time entry data and the bar graph.

Next, in block 512, the notes fields for the time entries (or any other fields including text describing the work performed by a time keeper and associated with the time entry) are filtered based upon matter level and/or engagement level filter keywords to hide the notes including any excluded keywords. Then, in block 514 a list of entries is generated including only those fields (e.g., timekeeper, rate, task, notes) for which the client user has permission to view. The list of entries may be grouped and/or sorted by engagement and/or matter as appropriate, and the actual entries may be initially hidden on the display. For example, display 430 of FIGS. 13-14 displays a list 444 of matter entries that, when selected, unhide a set of initially hidden time entries 454 (FIG. 14).

Then, in block 516, the display is generated, e.g., taking the form of one of displays 400, 430 or 480, and communicated to the client user for display on the client user's device. The display may, for example, take the form of an HTML web page. Where other display technology is used (e.g., a desktop or mobile application), it will be appreciated that at least a portion of the functionality used to generate a display may be incorporated into a client device. The sequence of operations is then complete.

Therefore, embodiments consistent with the invention facilitate the review and management of pre-billed time information such as time entries and related statistics by clients of service providers, and does so in a manner that controls access rights by various client and service provider users. Moreover, some embodiments consistent with the invention may enable multiple service providers to integrate with multiple clients, providing, from the service provider perspective, a central service with which to control access by multiple clients to their respective pre-billed time information, and, from the client perspective, a central service with which to view pre-billed time information for multiple service providers with which the client is engaged in the course of business.

Various modifications may be made without departing from the spirit and scope of the invention. For example, in some embodiments service provider users may be presented with similar data presentations and visualizations as client users. Also, in some embodiments additional accounting information regarding a client's account may be retrieved from an accounting system and presented to a client. In addition, in some embodiments a pre-billed time information service may be integrated with an accounting system to provide client access to both pre-billed and post-billed accounting information. In addition, while bar graph visualizations are used to display portions of the pre-billed time information, additional and/or alternative data visualizations may be used in other embodiments, e.g., through the use of other charts and/or graphs appropriate for the data being visualized.

In addition, while in the illustrated embodiments, responses to requests for pre-billed time information by a client (e.g., as discussed above in connection with FIG. 18) are handled by querying a database associated with the service that is periodically updated with data retrieved from each service provider accounting system, in other embodiments, some of all of the queries used to generate information for presentation to a client may be sourced directly from a service provider accounting system, e.g., through requests made through the API supported by a web-based service provider accounting system. Furthermore, while in the illustrated embodiments, the pre-billed time information service does not update any of the information retrieved from a service provider accounting system, in other embodiments, such a service may be provided with write access to modify data stored in a service provider accounting system. Also in the illustrated embodiments, it may be desirable to provide only limited exposure to invoices, e.g., so that clients are only able to view invoice balances and are not able to pay those invoices through the service. However, in other embodiments, additional invoice details, e.g., time entries, expense line items, etc. may be displayed to clients, and a mechanism to support client payment may also be provided.

Other modifications and advantages will be apparent to one of ordinary skill in the art. Therefore, the invention lies in the claims hereinafter appended.

What is claimed is:

1. A method of providing client access to pre-billed time information associated with work performed by a service provider on behalf of the client, the method comprising:
retrieving pre-billed time information from an accounting system;
controlling access to the pre-billed time information; and
in response to a request from the client user to which access has been granted for the pre-billed time information, communicating the pre-billed time information to the client user.

2. The method of claim 1, wherein access to the pre-billed time information for the client user is managed by a service provider user.

3. The method of claim 2, wherein controlling access includes:
communicating an invite to the client user in response to user input received from the service provider user; and
establishing an account for the client user after the invite is communicated to the client user.

4. The method of claim 3, further comprising:
communicating a second invite to a second service provider user in response to user input received from the client user; and
establishing an account for the second service provider user after the invite is communicated to the second service provider user.

5. The method of claim 2, wherein the pre-billed time information is associated with a plurality of matters, the method further comprising controlling access by the client user to the pre-billed time information on a matter-by-matter basis in response to user input from the service provider user.

6. The method of claim 5, further comprising communicating a message to the service provider user in response to a client user request to be granted access to pre-billed time information associated with a first matter among the plurality of matters to which the client user does not have access.

7. The method of claim 2, wherein the pre-billed time information includes a plurality of time entries, each time entry including a plurality of fields selected from the group consisting of a timekeeper, a billing rate, a task and a note, the method further comprising controlling access by the client user to selected fields in the plurality of time entries in response to user input from the service provider user.

8. The method of claim 2, wherein the pre-billed time information includes a plurality of time entries, each time entry including at least one field, the method further comprising hiding data in the field from the client user based upon a filter criterion set by the service provider user.

9. The method of claim 8, wherein the filter criterion includes at least one keyword, wherein the field in each time entry includes text describing work performed in association with such time entry, wherein hiding data in the field from the client user includes communicating at least one time entry to the client user with text excluded from the field in response to the text matching the keyword.

10. The method of claim 1, wherein communicating the pre-billed time information to the client user includes communicating a plurality of unbilled time entries associated with work performed by the service provider to the client user.

11. The method of claim 10, further comprising communicating a message to a service provider user in response to a query by the client user directed at a particular unbilled time entry among the plurality of unbilled time entries, wherein the message includes pre-billed time information associated with the particular unbilled time entry and at least one control enabling the service provider user to respond to the client user using user input directed to the control.

12. The method of claim 1, wherein communicating the pre-billed time information to the client user includes communicating aggregated pre-billed time information associated with work performed by the service provider to the client user.

13. The method of claim 1, further comprising communicating a message to a service provider instructing the service provider to discontinue work on a matter in response to a stop work request generated by a client user while viewing pre-billed time information associated with the matter.

14. The method of claim 1, further comprising communicating a message to the client user in response to triggering of an activity alert, the activity alert including an alert criterion, the alert criterion including a threshold that, when exceeded by the pre-billed time information, triggers the activity alert.

15. The method of claim 14, wherein the alert criterion is associated with a particular matter, and wherein the alert criterion triggers the activity alert when an amount of time or a cost associated with the pre-billed time information for the particular matter exceeds the threshold.

16. The method of claim 1, wherein retrieving the pre-billed time information, controlling access to the pre-billed time information, and communicating the pre-billed time information to the client user are performed by a service external to the accounting system.

17. The method of claim 16, wherein retrieving the pre-billed time information includes accessing a web-based accounting system within which is stored the pre-billed time information for the service provider.

18. The method of claim 17, further comprising in response to user input from a service provider user, authorizing the service to access the pre-billed time information for the service provider in the web-based accounting system using a third party authorization framework supported by the web-based accounting system.

19. The method of claim 17, wherein retrieving the pre-billed time information includes issuing a plurality of queries to the web-based accounting system using an Application Programming Interface (API) supported by the web-based accounting system.

20. The method of claim 19, further comprising retrieving matter information through the API and updating a list of matters associated with the service provider using the retrieved matter information.

21. The method of claim 16, wherein retrieving the pre-billed time information includes receiving the pre-billed time information from a standalone accounting system.

22. The method of claim 21, wherein the standalone accounting system is installed on a private network of the service provider behind a firewall, and wherein retrieving the pre-billed time information includes receiving the pre-billed time information from an adapter installed behind the firewall and in communication with the standalone accounting system.

23. The method of claim 22, wherein the adapter is configured to push the pre-billed time information to the service.

24. The method of claim 23, wherein the adapter is associated with a user account on the standalone accounting system and is configured to retrieve the pre-billed information from the standalone accounting system by issuing at least one query to the standalone accounting system while signed in to the user account.

25. The method of claim 23, wherein the adapter is configured to connect to the service through an Application Programming Interface (API) supported by the service.

26. The method of claim 25, wherein the adapter is further configured to retrieve a list of matters when connected to the service and retrieve pre-billed time information associated with each matter in the list of matters from the standalone accounting system.

27. The method of claim 16, wherein the service is coupled to a plurality of accounting systems associated with a plurality of service providers, wherein the plurality of accounting systems store pre-billed time information associated with work performed by the plurality of service providers for a plurality of clients, the method further comprising:
registering accounts for a plurality of service provider users and a plurality of client users;
controlling access to the pre-billed time information of each service provider by each client user in response to user input from a service provider user associated with such service provider;
retrieving pre-billed time information from the plurality of accounting systems; and
in response to user input from each client user, communicating pre-billed time information to such client user if so authorized by the service provider user associated with such pre-billed time information.

28. The method of claim 1, wherein access to the pre-billed time information for the client user is managed by a service provider administrator user, and wherein the service provider administrator user manages access to a plurality of additional users associated with the service provider.

29. The method of claim 1, wherein the client user is a client administrator user associated with an organization, wherein the organization includes a plurality of additional users associated with the client, wherein access rights to the pre-billed time information are granted to the organization by a service provider user, and wherein access rights to at least one additional user associated with the client are further restricted from the access rights granted to the organization by the client administrator user.

30. The method of claim 1, wherein the pre-billed time information communicated to the client user is configured for display on a mobile device.

31. The method of claim 1, further comprising, in response to the request from the client user, communicating pre-billed expense information to the client user.

32. An apparatus, comprising:
at least one processor; and
program code configured upon execution by the at least one processor to provide client access to pre-billed time information associated with work performed by a service provider on behalf of the client by retrieving pre-billed time information from an accounting system, controlling access to the pre-billed time information, and in response to a request from the client user to which access has been granted for the pre-billed time information, communicating the pre-billed time information to the client user.

33. A program product, comprising:
a computer readable medium; and
program code resident on the computer readable medium and configured upon execution by at least one processor to provide client access to pre-billed time information associated with work performed by a service provider on behalf of the client by retrieving pre-billed time information from an accounting system, controlling access to the pre-billed time information, and in response to a request from the client user to which access has been granted for the pre-billed time information, communicating the pre-billed time information to the client user.

34. A method of providing client access to pre-billed time information associated with work performed by a plurality of service providers on behalf of a plurality of clients, the method comprising:
interfacing a pre-billed time information service with a plurality of service provider accounting systems external to the pre-billed time information service and associated with the plurality of service providers to retrieve pre-billed time information associated with a plurality of clients from the plurality of service provider accounting systems on a real-time basis;
for each service provider among the plurality of service providers, establishing access rights for clients of such service provider in the pre-billed time information service in response to user input received from at least one service provider user associated with such service provider; and
for each client among the plurality of clients, in response to at least one request from a client user associated with such client, communicating pre-billed time information associated with work performed for such client by at least a subset of the plurality of service providers and for which access rights have been established.

35. The method of claim 34, further comprising, for a first client among the plurality of clients, and in response to a request from a first client user associated with the first client, communicating aggregated pre-billed time information associated with a plurality of service providers for which pre-billed time information for the first client is available.

36. The method of claim 34, wherein the plurality of service provider accounting systems includes at least one web-based service provider accounting system and at least one standalone service provider accounting system.
